(19) United States
(12) Patent Application Publication
(10) Pub. No.: US 2007/0282870 A1
(43) Pub. Date: Dec. 6, 2007

(54) Method Of And Device For Querying Of Protected Structured Data

(75) Inventors: Willem Jonker, Eindhoven (NL); Richard Brinkman, Enschede (NL); Jeroen Mathias Doumen, Enschede (NL); Berry Schoenmakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,690

(22) PCT Filed: Apr. 29, 2005
(86) PCT No.: PCT/IB05/51412

§ 371 Date: Jun. 19, 2007

(30) Foreign Application Priority Data
May 28, 2004 (EP) 04102375.5

(51) Int. Cl. G06F 17/30

(52) U.S. Cl. 707/100; 707/E17.012

(57) ABSTRACT

Method of and device for querying of protected data structured in the form of a tree. A corresponding tree of node polynomials is constructed such that each node polynomial evaluates to zero for an input equal to an identifier assigned to a node name occurring in a branch of the data tree starting with the node in question. A tree of blinding polynomials and a tree of difference polynomials are constructed such that each polynomial in the tree of node polynomials equals the sum of the corresponding polynomial in the tree of blinding polynomials and the corresponding polynomial in the tree of difference polynomials. The blinding tree is given to a client, the difference tree to a server. By combining the outcomes of the evaluations of the client and the server, it is possible to identify nodes that match a given query.

There is an increasing need to store data such as XML-structured documents in remote databases. When such data contains sensitive information, for example patient information or commercially valuable metadata for (audio)visual content, it should be protected. The normal approach is to encrypt the data before storing it in the remote database. The problem then arises how a client device can subsequently query the database. The most obvious solution is to download the whole database locally and then perform the query. This of course is terribly inefficient. Another option is to provide the database server with the decryption key, but this is not always desirable as it requires a complete trust in the database server system and the people who manage it.

Therefore, a problem in this field is how to enable a server to efficiently query encrypted data, especially XML-structured data. The W3C recommends an “XML Encryption Syntax” to allow the encryption of XML data using a combination of symmetric and public keys, where element content is encrypted by means of a symmetric key that in turn is encrypted by means of the public key of the recipient. See W3C Note “XML Encryption Requirements”, 4 Mar. 2002 at http://www.w3.org/TR/xml-encryption-req and W3C Recommendation “XML Encryption Syntax and Processing”, 10 Dec. 2002 at http://www.w3 .org/TR/xmlenc-core/.

Since query is a fundamental operation that is carried out on XML data, a first step to proceed is to address the issue around querying of encrypted XML data. A straightforward approach to search on encrypted XML data is to decrypt the encrypted data first, and then do the search on the decrypted XML data. However, this inevitably incurs a lot of unnecessary decryption efforts, leading to a very poor query performance, especially when the searched data is huge, while the search target comes only from a small portion of it.

Advantageously, the invention provides for a computer-implemented method of enabling querying of protected data as claimed in claim 1 and a corresponding device as claimed in claim 9. The invention also provides for a client device as claimed in claim 11.

It is assumed the data is organized in a tree. A tree of node polynomials is constructed which corresponds in structure to the tree in which the data is organized. Each node polynomial in that tree evaluates to zero for an input equal to an identifier assigned to a node name occurring in a branch of the tree starting with the node in question.

The constructed tree is split into a client part and a server part. The client part is chosen randomly and the server part is the difference with the original data tree. In response to a query, client and server both evaluate the polynomials in their parts and supply the results to the query originator (which may be the client itself). Neither of these results contains enough information to reconstruct the original data. Hence the data remains protected.

By combining the outcomes of the evaluations of the client part and the server part, it is possible to identify nodes that match a given query. The sum of the evaluations of the parts is for any particular node name the same as the evaluation of the original node polynomial for that particular node name. And this evaluation is zero if the node name of the query matches the node name of that particular node name. Hence, the query can be answered without the server knowing the answer as well.

Having found the matching nodes, their (encrypted) content can be retrieved from the server and decrypted by the client.

In a preferred embodiment data nodes in the tree are transformed into a trie representation, whereby a first character subsequent to a second character in the data segment is represented as a child node of said second character. This enables searching of data contents of elements in the encrypted document.

These and other aspects of the invention will be apparent from and elucidated with reference to the illustrative embodiments shown in the drawings, in which:

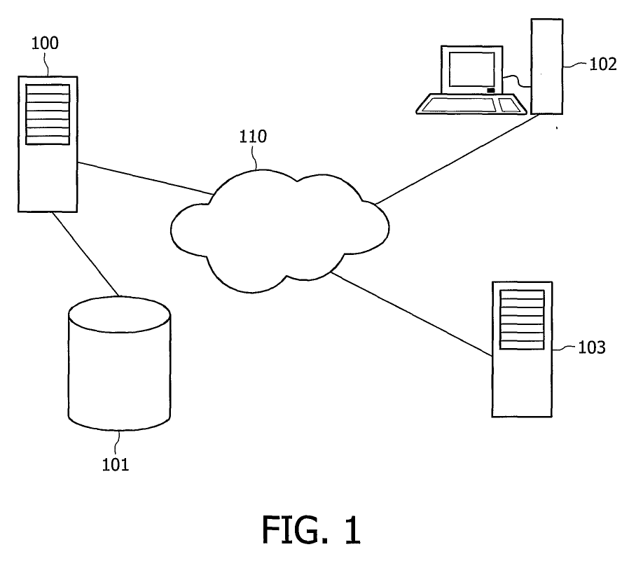

FIG. 1 schematically illustrates a broad overview of the system according to the invention;

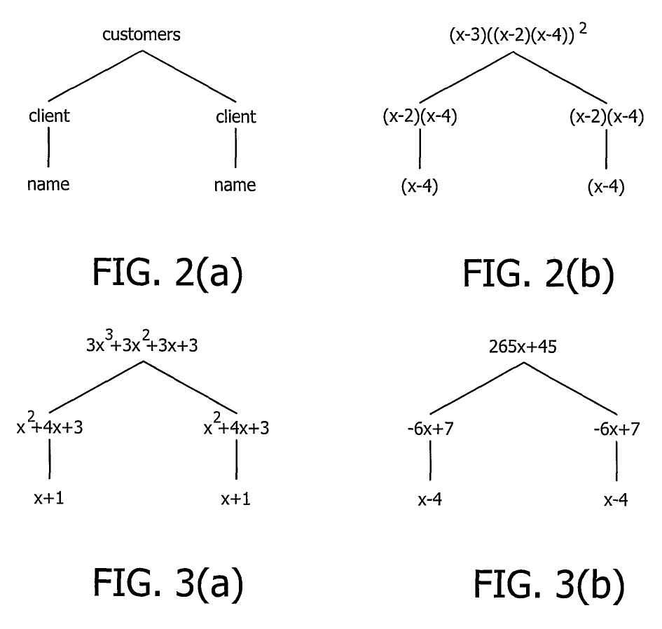

FIG. 2(a) illustrates a tree representation an example XML-based document;

FIG. 2(b) shows a tree of node polynomials assigned to node names;

FIG. 3(a) shows a tree of node polynomials in F₅[x];

FIG. 3(b) shows a tree of node polynomials in Z[x²+1];

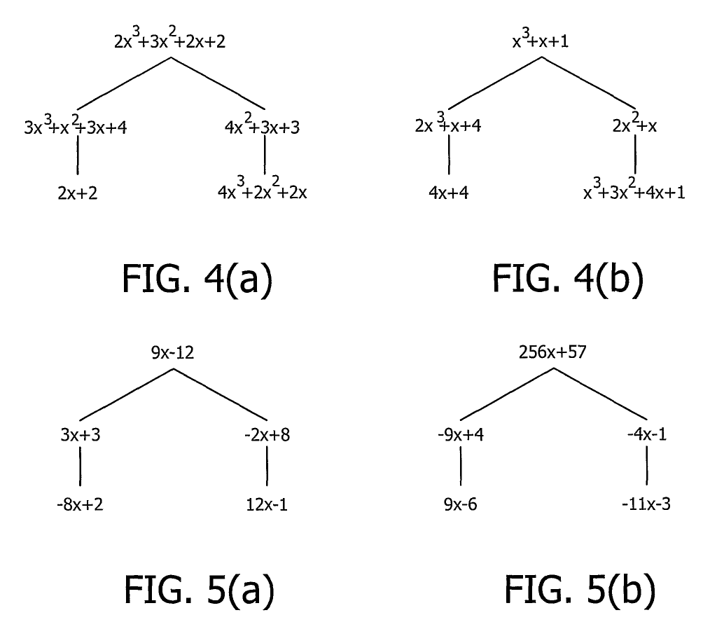

FIG. 4(a) shows a tree of blinding polynomials in F₅[x];

FIG. 4(b) shows a tree of difference polynomials in F₅[x];

FIG. 5(a) shows a tree of blinding polynomials in Z[x²+1];

FIG. 5(b) shows a tree of difference polynomials in Z[x²+1];

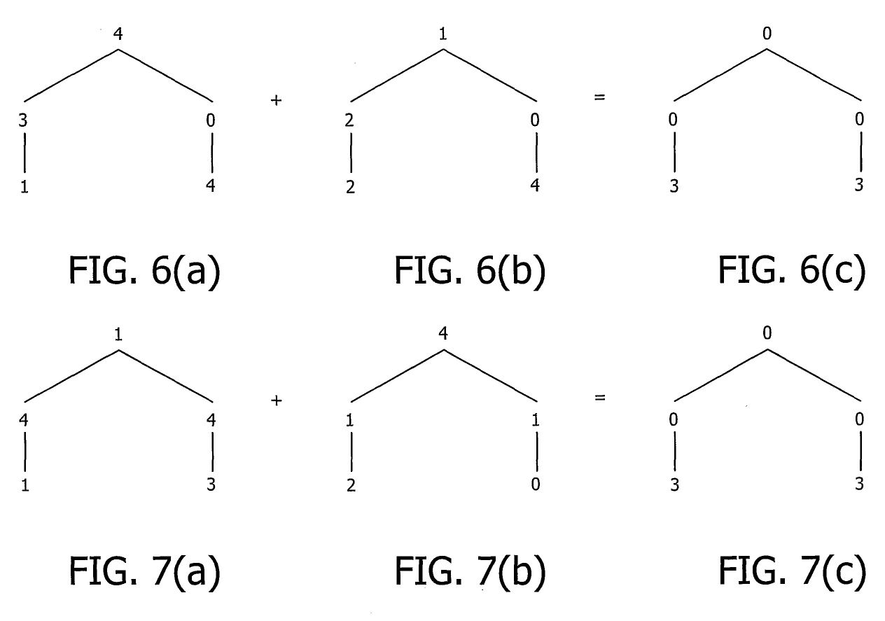

FIG. 6(a) shows an evaluation in F₅[x] of all polynomials of the tree of blinding polynomials of FIG. 4(a);

FIG. 6(b) shows an evaluation in F₅[x] of all polynomials of the tree of difference polynomials of FIG. 4(b);

FIG. 6(c) shows the respective sums in F₅[x] of the respective evaluations of the polynomials of FIGS. 6(a) and (b);

FIG. 7(a) shows an evaluation in Z[x²+1] of all polynomials of the tree of blinding polynomials of FIG. 5(a);

FIG. 7(b) shows an evaluation in Z[x²+1] of all polynomials of the tree of difference polynomials of FIG. 5(b);

FIG. 7(c) shows the respective sums in Z[x²+1] of the respective evaluations of the polynomials of FIGS. 7(a) and (b);

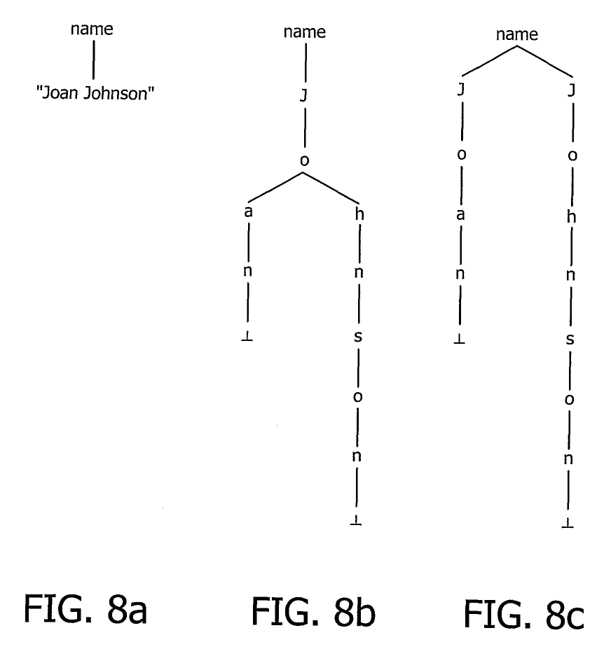

FIG. 8(a) shows an example of an XML element with data content;

FIG. 8(b) shows the compressed trie representation of this XML element; and

FIG. 8(c) shows the uncompressed trie representation of this XML element.

Throughout the figures, same reference numerals indicate similar or corresponding features. Some of the features indicated in the drawings are typically implemented in software, and as such represent software entities, such as software modules or objects.

FIG. 1 schematically illustrates a broad overview of the system according to the invention. A server 100 maintains a database 101 with data and is configured to answer queries from one or more clients 102, as is well known in the art. The queries are received over a network 110 such as the Internet. The data stored in the database 101 has been supplied by data origin system 103. This system 103 may be one of the clients 102 but could also be a separate system. The data could of course originate from multiple sources and be consolidated by the server 100.

For example, the clients 102 could be terminals in a hospital on which patient information is entered. The patient information is then stored in the database 101 which, for one reason or another, is at a remote location. Patient information must be protected for privacy reasons. Later, the clients 102 are used to query the database 101 so as to retrieve patient information entered previously. In such case, the data origin system 103 is the same as the clients 102.

In another embodiment, the data origin system 103 could be a content provider that makes available content such as movies or music to customers. In addition the content provider allows its customer to query a database with metadata such as title or artist of the content it sells. For reasons of efficiency in the provider may want to outsource management of the database to a third party. As such a database is quite valuable commercially, the provider needs to protect the data in the database.

It is assumed that the data has a tree-like structure, such as is the case with XML-based documents. In XML documents, each node has a name and possibly a value. There is not more than one path between each two nodes. An example XML-based document is shown below; its tree representation is illustrated in FIG. 2(a).
1. <?xml version=‘1.0’?>
2. <customers>
3. <client><name>Smith</name></client>
4. <client><name>Jones</name></client>
5. </customers>

In FIG. 2(a), it can be seen that the ‘customers’ element becomes the root or topmost node of the tree. Below it are two nodes named ‘client’ which each have one “child” node named ‘name’. The ‘name’ nodes are leaf nodes, i.e. they have no child nodes.

The data could also be an indexing structure to allow searching of flat text files such as e-mail messages. Unstructured data could be transformed into a tree-like structured format first.

It is desirable to protect the data so that there is not enough information on the server 100 to recover the data. Therefore the data origin system 103 supplies the data in protected form as follows.

Each node name first is assigned an identifier and a corresponding identifying polynomial i(x) which evaluates to zero for x equal to the node name identifier. An example mapping of node name to identifiers is shown below in Table 1. The identifiers should be unique for each name. They can be chosen (pseudo-)randomly or be assigned by an operator, for example. With this mapping the identifying polynomials i(x) can be constructed. Preferably the identifying polynomials are first-degree polynomials, although this is not necessary. First-degree polynomials only evaluate to zero for exactly one input. Using higher degree polynomials means that the answers have to be filtered to find the correct one.

A simple construction, used in the example embodiment used throughout this document, is to use polynomials of the form i(x)=x−n, where n equals the identifier assigned to the node name.

If it is desirable to keep node names themselves a secret from the server 100, the mapping of node names to identifiers should of course not be supplied to server 100. The server 100 does not need this information to be able to perform queries, as will become apparent below.

Next, every node name is assigned a corresponding node polynomial n(x). For a leaf node, its node polynomial is equal to its identifying polynomial. For a non-leaf node, its node polynomial is computed as the product of its identifying polynomial and the node polynomials of all its child nodes. This is illustrated in FIG. 2(b).

To avoid polynomials of large degree, it is preferred to work in finite fields, for example Fₚ[x] or Z[r(x)]. Using finite fields does not lose any information.

In the first example, the coefficients of the polynomials are reduced modulo p. If p is prime, then ∀a ε Fₚ:a^{p-1}≡1(mod p). Therefore every polynomial can be reduced to a polynomial of degree less than p−1 with coefficients in Fₚ. This is illustrated in FIG. 3(a) with the choice of p=5.

In the second example, the polynomial is reduced modulo an irreducible polynomial r(x). The degree of the polynomials now is less than the degree of r(x). However, the coefficients are elements of Z, i.e. whole numbers, and can get quite large for data structures with a lot of node names. This is illustrated in FIG. 3(b) with the choice of r(x)=x²+1.

To summarize, below is an overview of node names, assigned identifiers, identifying polynomials and node polynomials for the node names of the example embodiment.

TABLE 1

| | | Identifying | |
|---|---|---|---|
| Node name | Identifier | polynomial | Node polynomial |
| customers | 3 | x − 3 | (x − 3)((x − 2)(x − 4))² |
| client | 2 | x − 2 | (x − 2)(x − 4) |
| name | 4 | x − 4 | x − 4 |

Having constructed the tree of polynomials, the next step is to split the tree into a server part and a client part. The server part is stored on the server 100 and the client part is stored on the client(s) 102 that will query the server later on. If the data origin system 103 is not the same system as the client 102, the client part needs to be transmitted to the client 102.

In a preferred embodiment, the tree of polynomials is split as follows. Each individual node is assigned its own (pseudo)randomly chosen blinding polynomial of the same degree as their node polynomial. This means that two nodes having the same name usually have different blinding polynomials assigned. An example of such assignment to the example tree of FIG. 2(a) is shown in FIG. 4(a). The tree in FIG. 4(a) will be referred to as a tree of blinding polynomials. The polynomials are all in F₅[x].

Next, for each node a difference polynomial is computed such that the sum of the blinding polynomial and the difference polynomial equals the node polynomial. For the example tree the corresponding “tree of difference polynomials” is illustrated in FIG. 4(b). For each node it is true that if the blinding polynomial in FIG. 4(a) of that node is added to the corresponding difference polynomial in FIG. 4(b), the result is the node polynomial for that node of FIG. 3(a). For instance, the root node of FIG. 4(a) plus the root node of FIG. 4(b) is
(2x³+3x²+2x+2)+x³+x+1)=3x₃+3x₂+3x+3
which equals the root node of FIG. 3(a).

The corresponding example in Z[x²+1] is illustrated in FIGS. 5(a) and 5(b). If the root node of FIG. 5(a) is added to the root node of FIG. 5(b), the result is the root node of FIG. 3(b):
(9x−12)+(256x+57)=(265x+45)

One of the client 102 and the server 100 is given the tree of blinding polynomials, and the other is given the tree of difference polynomials. Neither of these trees contains enough information to reconstruct the original tree of polynomials. The trees can be transmitted over a network or be made available on a data carrier such as a CD-ROM.

In principle, it does not matter which of the client 102 and the server 100 receives which tree. However, if the client 102 has limited storage capacity, it is advantageous to assign the tree of difference polynomials to the server 100. The client 102 can then be supplied with only the seed used to initialize the pseudo-random number generator with which the blinding polynomials were generated. The client 102 can then regenerate the blinding polynomials whenever necessary. For example, a mobile phone has limited storage capacity but is powerful enough to make the necessary computations.

After the trees of blinding and difference polynomials have been supplied to client and server, the client can query the server. First simple element lookups are discussed, i.e. find a node in the tree given the node name.

The W3C Recommendation called XPath describes searching for XML documents containing a certain path. An element lookup for nodes with name ‘client’ is denoted in XPath as “//client”. Normally the server 100 perform such a lookup by traversing the whole tree and comparing all node names with the name ‘client’. This is rather inefficient and moreover not possible if the server 100 does not have the actual node names with only the tree of different polynomials (or blinding polynomials).

According to the invention, the client 102 first determines the identifier assigned to the node name in question. For the name ‘client’, the identifier is ‘2’ as shown above. The client 102 then asks the server 100 to evaluate the polynomials in its tree for x equal to that identifier, in the example x=2, and to return the results. Preferably the server 100 should return each outcome of each polynomial as soon as it has been computed, so that the client 102 can signal to the server 100 when to stop computing so as to avoid making further unnecessary calculations. This will be explained below.

The client 102 also itself evaluates its polynomials one by one for the given value of x=2. Furthermore the client 102 calculates for each node the sum of its own evaluation and the evaluation result returned for that node by the server 100. If this sum equals zero, then the node polynomial for that node contains a factor (x−2). This means that either the node has node name ‘client’ or there is a node somewhere below it with that name.

If the sum is nonzero, then the node polynomial does not contain a factor (x−2). This means that there is no node name ‘client’ anywhere below this node. Hence, it is not necessary to search further in this branch. The client 102 can now signal to the server 100 that it can stop evaluating polynomials in that branch.

Each node for which the sum equals zero and the sum(s) of its child(ren) does not equal zero represents an answer to the query. This is illustrated in FIGS. 6(a)-(c). All evaluations are in F₅[x]. The same example in Z[x²+1] is illustrated in FIGS. 7(a)-(c).

FIG. 6(a) shows the evaluation of all polynomials of the client tree (here the blinding polynomials). FIG. 6(b) shows the evaluation of all polynomials of the server tree (here the difference polynomials). FIG. 6(c) shows the respective sums of the respective evaluations of the polynomials of FIGS. 6(a) and (b). As can be verified by comparing FIG. 6(c) to FIG. 2(a), the nodes with the name ‘client’ in FIG. 2(a) have zero sums and their children have nonzero sums. The node ‘customers’ has a zero sum and also children with zero sums, indicating that there is one or more node with name ‘client’ below this node.

This approach does not deliver completely accurate results if a node name can occur at multiple levels in the tree. For example, if the data were structured as follows:
1. <?xml version=‘1.0’?>
2. <customers>
3. <client>
4. <name>
5. <client/>
6. </name>
7. </client>
8. </customers>
   then the node named ‘client’ at line 3 would not be identified as a matching node. This node has a child node with zero sum because of the fact that there is a descendent node also with the name ‘client’, namely at line 5.

A better way to identify matching nodes which does not have this problem is available. It requires reconstructing the original node polynomials for some of the nodes. Assume the client 102 has received the tree of blinding polynomials. After having received the answers from the server 100 and having identified certain nodes as above, the client 102 requests from the server 100 for each identified node its difference polynomial and the difference polynomials of the direct children of that node. For example, in the example of FIG. 6(c) the root node is a matching node. The client 102 would request the difference polynomial for the root node and for the two nodes directly below the root node.

The client 102 can now reconstruct for each of the nodes in question the node polynomial by simply adding up the relevant blinding polynomial and difference polynomial. Then the node polynomial for the node with zero sum is divided by the node polynomials of its direct children. This reveals the identifying polynomial of the node with zero sum. It can then be easily verified whether the identifying polynomial evaluates to zero for the given query or not. From this it can be concluded whether the node in question matches the query or the answer should be sought in one of the children.

It is further possible to check the correctness of the answer from the server. Let f be the node polynomial of a node and qₗ, . . . , qₙ the node polynomials of its n direct child nodes. To check the correctness of an answer, the following equation must be solved for t:

$$f = ( x - t ) {\prod }_{i = 1}^{n} {q}_{i} ( mod r )$$

The value of t should be equal to the identifier of the node name used in the query. In the example, t should be equal to 2 because this identifier was assigned to node name ‘client’ used in the query. This can be solved as follows:
d=d(r)
f−q₁ . . . qₙ(x−t)=0(mod r)
from which it follows that
a_{d-1}x^{d-1}+a_{d-2}x^{d-2}+ . . . +a₁x+a₀=0
where each aᵢ is a function in t. This can be rewritten as the following series of equations:
a_{d-1}(t)=0
a_{d-2}(t)=0
. . .
a₀(t)=0

A single equation is enough to solve t. The other equations may be used to check the answer provided by the server. If the server is trusted to give correct answers, only the last equation is enough. In that case only the constant factor of each polynomial stored on the server has to be transmitted. This reduces bandwidth and increases efficiency, but decreases security.

Having found matching nodes, the client 102 can now request the (encrypted) content of these nodes from the server 100 and decrypt the content locally. This way only the content of the matching node(s) needs to be transmitted from server 100 to client 102 instead of the whole encrypted database.

In some applications, nodes may be empty, i.e. have no content. All information is then contained in the node names and the structure of the nodes in the tree.

The invention also allows more elaborate XPath queries to be performed on the protected data. A query such as “//a/b//c/d/e” can of course be evaluated from left to right. That is, first search the tree for occurrences of ‘a’, then search within the branches below the nodes with that name for nodes named ‘b’, and so on. It is much more efficient to evaluate the whole query at once.

Every polynomial in the tree contains the roots of all its descendents. This allows a single query to find all elements that contain any specific descendent node(s). Resolving the example query given above requires the following steps:
1. From the root node find all elements with name ‘a’ that have elements with names ‘b’, ‘c’, ‘d’ and ‘e’ somewhere deeper in the tree.
2. From all found elements with name ‘a’, find all direct children with name ‘b’ that have elements with names ‘c’, ‘d’ and ‘e’ somewhere deeper in the tree.
3. From all found elements with name ‘b’, find all descendents with name ‘c’ that have elements with names ‘d’ and ‘e’ somewhere deeper in the tree.
4. From all found elements with name ‘c’, find all direct children with name ‘d’ that have elements with name ‘e’ somewhere deeper in the tree.
5. From all found elements with name ‘d’, find all direct children with name ‘e’.

The above embodiments assume that element names are chosen from a fixed sized set, e.g. described in a DTD, but cannot be used for the contents of the XML elements because the number of different data elements can be infinitely large. Below an embodiment is presented that is also suited for searching in data.

In this embodiment, a data string in the original XML document is translated to a path of nodes where each node is chosen from a small set. Preferably this small set is the alphabet, i.e. {‘A’, . . . ‘Z’, ‘a’ . . . ‘z’}, although of course other characters may be included in the set as well.

The set may be chosen so that all data elements can be expressed using only characters from the set. However, it is also possible to construct the set by choosing only a limited subset of all the characters used in the data elements. For instance, punctuation marks, spaces and so on could be excluded. The choice of set determines what kind of queries can be performed on data. If the set contains only the alphabet, then only queries for words can be performed.

Having created the set, the next step is to transform the data nodes are to their so-called ‘trie’ representation. This type of representation is described in Edward Fredkin, Bolt Beranek, and Newman. Trie memory. Communications of the ACM, 3(9):490-499, September 1960. Effectively, in a trie representation of a data segment a first character subsequent to a second character in the data segment is represented as a child node of said second character.

FIG. 8(a) shows an example of an XML element with data content. In this example, the element is called “name” and contains the data “Joan Johnson”.

FIG. 8(b) shows the compressed trie representation of this XML element. FIG. 8(c) shows the uncompressed trie representation of this XML element. An uncompressed trie stores exactly the same information as the original, whereas the compressed trie loses the order and cardinality of the words. In this example a stringis split into words, representented by paths, and then each path is split into several characters. Other ways of splitting the string into nodes are very well possible. As can be seen in these figures, the character “o” subsequent to the character “J” in the data segment “Joan” is represented as a child node of the node for “J”.

This process creates as many new element names as there are elements in the set. For instance, when the text is split into the lowercase letters of the alphabet (a, b, . . . , z), this gives 26 new names. In order to keep the polynomials as small as possible, a prime factor p of 29 is reasonable. Each letter will now take p*log_{—}2(p) bits=18 bytes. Thus in the worst case scenario (when there are no common prefixes) the size of the text is exploded by this constant. However the larger the document, the larger the number of common prefixes and hence the size increase will be less. There is even a small chance that the transformed document is smaller than the original document.

Having translated the original XML tree into a (compressed) trie, the same strategy as above can be used to encode the document. It is now possible to search the data contents of the XML document. For example, this query is now possible:
/name[contains(text( ), “Joan”)]
   This query searches for all text (data) nodes that contain the text “Joan”. This query is first translated to
/name[//J/o/a/n]
   and subsequently to
/map(name)[//map(J)/map(o)/map(a)/map(n)]
   Simple regular expressions like . and .* can be mapped to their trie-equivalents * and //.

Using the search strategy as set out above, first the XML element with the name “name” is located. The next step is to determine whether this element contains the data string “Joan”. This is done by performing the query “J/o/a/n” on this element (and its children), exactly as above. In other words, the query “Joan” is transformed into a query for the trie representation of “Joan”.

As can be seen in FIG. 8(b) and (c), the first (and only) child node below the node “name” is the node with the name “J”. Below that is a node “o”, followed by nodes for the other characters in “Joan”: “a” and “n”. Thus, the query “J/o/a/n” using the strategy as set out above will reveal whether the node “name” contains the value “Joan”.

As explained earlier, this embodiment makes it possible to search the data in the document that is composed using the characters in the set selected initially. With the set {‘A’, . . . ‘Z’, ‘a’, . . . , ‘z’} queries for words can be performed. Characters in the data that are not in the set are preferably omitted in the trie, although they could also be mapped to a specially designated character. By omitting such characters in the trie, such characters do not need to be specified in the query. For instance, in the trie of FIG. 8(b) the query for “Joan Johnson” will be successful even though the space character in the query between “Joan” and “Johnson” is not present in the trie.

In a further refinement, the set of characters is constructed by determining all unique characters used in data elements. Alternatively, the XML document can be examined to determine its encoding, from which it can be determined which character set is used. The set then is chosen as equal to the character set. This gives a relatively large set, especially when the Unicode character set is used, but it is now possible to search for every possible query.

To make the necessary computations, the server 100 and the client 102 can be provided with specially-written software and/or hardware. As most calculations are evaluations of polynomials, a standard CPU can be used to run the software.

It should be noted that the above-mentioned embodiments illustrate rather than limit the invention, and that those skilled in the art will be able to design many alternative embodiments without departing from the scope of the appended claims.

For example, it is possible to store the tree of blinding polynomials on a first server and the tree of difference polynomials on a second server. A client can then requested both servers to evaluate their polynomials for a given value of x, and only has to add up the results. This way, the client does not have to evaluate any polynomials itself.

The tree with node polynomials can be split into more than two trees, so that more than two parties are needed to resolve a query. One straightforward way to do this is to choose multiple (pseudo)-randomly blinding polynomials for each node. The difference polynomial for each node is then chosen such that the sum of all blinding polynomials for that node and the difference polynomial equals the node polynomial for that node. Each party receives one of the trees of blinding polynomials or the tree of the difference polynomials. By adding up all evaluations of all polynomials for one node, it can be verified whether the node matches the query.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. The “means” recited in the claim can be embodied by respective software libraries or modules. Multiple means can be embodied as a single computer program.

In the device claim enumerating several means, several of these means can be embodied by one and the same item of hardware. The mere fact that certain measures are recited in mutually different dependent claims does not indicate that a combination of these measures cannot be used to advantage.

1. A computer-implemented method of enabling querying of protected data, the data being organized as a tree comprising nodes having respective node names, each node name having been assigned a unique identifier, the method comprising:
constructing a tree of node polynomials corresponding in structure to the tree in which the data is organized, such that each node polynomial evaluates to zero for an input equal to an identifier assigned to a node name occurring in a branch of the tree starting with the node in question,
constructing a tree of blinding polynomials and a tree of difference polynomials both corresponding in structure to the tree in which the data is organized, such that each polynomial in the tree of node polynomials equals the sum of the corresponding polynomial in the tree of blinding polynomials and the corresponding polynomial in the tree of difference polynomials, and
making one of the tree of blinding polynomials and the tree of difference polynomials available to a server system and the other of the tree of blinding polynomials and the tree of difference polynomials available to a client device.

2. The method of claim 1, further comprising assigning each node name an identifying polynomial in x which evaluates to zero for x equal to the unique identifier.

3. The method of claim 2, in which the identifying polynomial is a first-degree polynomial.

4. The method of claim 2, further comprising constructing the tree of node polynomials such that for each node in the tree, if the node is a leaf node, the node polynomial equals the identifying polynomial of the node, and otherwise the node polynomial equals the product of its identifying polynomial and the node polynomial of its child nodes.

5. The method of claim 1, in which the tree of blinding polynomials is made available to the client device and the tree of difference polynomials is made available to the server system.

6. The method of claim 1, in which the tree of blinding polynomials is constructed by pseudo randomly choosing coefficients of the blinding polynomials.

7. The method of claim 5, in which the tree of blinding polynomials is made available to the client device by making available to the client device a seed used to initialize the pseudo-random number generator with which the coefficients of the blinding polynomials were generated.

8. The method of claim 1, comprising
constructing multiple trees of blinding polynomials, such that each polynomial in the tree of node polynomials equals the sum of the corresponding polynomials in the trees of blinding polynomials and the corresponding polynomial in the tree of difference polynomials, and
making available one of the multiple trees of blinding polynomials or the difference polynomial to the server system, and making available the remaining trees to respective client devices.

9. The method of claim 1, further comprising
transforming data nodes in the tree into a trie representation, whereby a first character subsequent to a second character in the data segment is represented as a child node of said second character.

10. A computer-implemented device for enabling querying of protected data, the data being organized as a tree comprising nodes having respective node names, each node name having been assigned a unique identifier, the device comprising:
means for constructing a tree of node polynomials corresponding in structure to the tree in which the data is organized, such that each node polynomial evaluates to zero for an input equal to an identifier assigned to a node name occurring in a branch of the tree starting with the node in question,
means for constructing a tree of blinding polynomials and a tree of difference polynomials both corresponding in structure to the tree in which the data is organized, such that each polynomial in the tree of node polynomials equals the sum of the corresponding polynomial in the tree of blinding polynomials and the corresponding polynomial in the tree of difference polynomials, and
means for making available one of the tree of blinding polynomials and the tree of difference polynomials to a server system and the other of the tree of blinding polynomials and the tree of difference polynomials available to a client device.

11. The device of claim 10, configured to operate as the client device.

12. A client device for querying a server on protected data, the data being organized as a tree comprising nodes having respective node names, each node name having been assigned a unique identifier, comprising:
means for determining, in response to receiving a query for a node name, the unique identifier assigned to the node name,
means for communicating to a server system a request to evaluate the polynomials in the tree made available to the server system for an input equal to the determined identifier, p1 means for evaluating the polynomials in the tree made available to the client device for an input equal to the determined identifier,
means for determining if a sum of an outcome of an evaluation received from the server system and an outcome of an evaluation by the client device equals zero,
means for returning as an answer to the query a node for which the determined sum equals zero and the sum(s) of any child nodes of said node does not equal zero.

13. The client device of claim 12, further comprising
means for signalling to the server system to stop evaluating polynomials in a particular branch if an evaluation by the server system of a root node of said branch was nonzero.

14. The client device of claim 12, further comprising
means for transforming a query for a data segment contained in a particular node into a query for said particular node followed by a query for a trie representation of the data segment.

15. A computer program product, embedded in a computer readable medium, containing instructions to perform acts comprising:
constructing a tree of node polynomials corresponding in structure to the tree in which the data is organized, such that each node polynomial evaluates to zero for an input equal to an identifier assigned to a node name occurring in a branch of the tree starting with the node in question,
constructing a tree of blinding polynomials and a tree of difference polynomials both corresponding in structure to the tree in which the data is organized, such that each polynomial in the tree of node polynomials equals the sum of the corresponding polynomial in the tree of blinding polynomials and the corresponding polynomial in the tree of difference polynomials, and
making one of the tree of blinding polynomials and the tree of difference polynomials available to a server system and the other of the tree of blinding polynomials and the tree of difference polynomials available to a client device.

16. (canceled)
